(19) United States
(12) Patent Application Publication
(10) Pub. No.: US 2013/0332170 A1
(43) Pub. Date: Dec. 12, 2013

(54) METHOD AND SYSTEM FOR PROCESSING CONTENT

(71) Applicant: Gal Melamed, Tel Mond (IL)

(72) Inventor: Gal Melamed, Tel Mond (IL)

(21) Appl. No.: 13/977,268

(22) PCT Filed: Dec. 29, 2011
(86) PCT No.: PCT/IL11/00971

§ 371 Date: Jun. 28, 2013

Related U.S. Application Data
(60) Provisional application No. 61/428,374, filed on Dec. 30, 2010.

(51) Int. Cl. G10L 13/02

(52) U.S. Cl. CPC G10L 13/02
USPC 704/260

(57) ABSTRACT

Provided are a method and system for processing user input and web based content by transforming content to metadata and by using a plurality of vocabularies, including specific vocabularies (e.g. location dependent, culture dependent, personalized, non formal, and more), and other methods to process voice or non-voice content.

### FIELD OF THE INVENTION

The present invention relates to the field of interactive platforms for user interaction with content such as web content or content from connected devices, such as social networks and/or cell phones.

### BACKGROUND OF THE INVENTION

The use of web pages, web sites, web based social networks and other web platforms is becoming more and more prevalent in our everyday life, as is the use of instant messaging. Web based information and messages from various networks are available 24/7 in a variety of formats.

Transformation of one type of content format to another, such as, text to voice or voice to text, can be used as a means for upgrading user interaction with web based and other content. However, the wide variety of sources of content and platforms which offer content, make it difficult for a user to receive all his/her content in a single, user friendly application. For example, known voice services that enable content to be readout as speech information are not enabled for social network services. Also, known voice transcripts engines which typically reflect user's commonality by using medium/large sized vocabularies that are typically generic by design, are not enabled for various platforms, such as social networks, typically due to the wide variety of informal language used in many platforms.

### SUMMARY OF THE INVENTION

A method and system provided by the present invention enable adjustment of a wide variety of content to a single user preferred output method.

Embodiments of the invention enable multiple types of connected devices to gain bi-directional access to web content.

The method and system, according to one embodiment of the invention, provide a unique, complete solution for consuming and generating social network/instant messaging content, while using voice as a possible interface.

Embodiments of the invention provide a user vocal experience which offers faithful representation of original web/social network/instant messaging based textual content. Embodiments of the invention enable unique content creation which is automatically generated. Additional embodiments provide a prioritized queue of messaging which is personalized per user.

Embodiments of the invention provide personalized and location based vocabularies which enhance the system's voice recognition capabilities.

According to one embodiment there is provided a system for processing web based content, the system comprising a unit to collect content from a network or connected device; a processor to transform the collected content to metadata; and a processor to transform the metadata to output content to a network or connected device. The collected data may be in a first format and the output content may be in a second format, the second format being different than the first format. For example, the first format may be non-voice and the second format may be voice or vice versa. In another example the first format may be video with audio soundtrack and the second format may be the original audio accompanied by still image or thumbnail or intermediate frame of the video.

The system may also include a TTS engine to transform the metadata to voice representation.

The system may also include an advertisement server in communication with the unit for, collecting content from the network. The advertisement server may receive user characteristics and may output text, video, photo or voice content.

The system may further include a prioritizing processor to assign a priority to collected content, said prioritizing processor configured to send a signal to alert the user of incoming content.

Other embodiments of the invention provide a method for processing content, the method comprising transforming non-voice content to metadata; converting the metadata to a format suitable for submitting to a text-to-speech system; submitting the converted metadata to a text-to-speech system; and presenting the non-voice content as speech.

The non-voice content may be extracted from a network (e.g., a web resource, a cellular network or a combination of both, a social network, an instant messaging textual representation service or a combination of both or any combination of resources).

The non-voice content may include informal text. According to one embodiment the method includes extracting non-voice content from a web resource; identifying informal text within the non-voice content; and transforming the identified informal text to metadata prior to converting the metadata into a format suitable for submitting to a text-to-speech system.

According to one embodiment, transforming the identified informal text to metadata includes tagging the informal text in a platform specific manner to obtain tagged data; and transforming the tagged data to metadata.

The method may further include detecting the language of the tagged data; detecting misspelled content; correcting spelling mistakes in the misspelled content; detecting informal text content; and transforming the informal text content to a format suitable for submitting to a text-to-speech system.

According to one embodiment the misspelled content (which may be case insensitive) is detected by using a dictionary of the detected language.

According to another embodiment the misspelled content is detected by using metadata, the metadata comprising web related content. The misspelled content may include successive words with no blank spaces in between the words with or without special characters (e.g. hash tag, question mark, etc) in between the words.

According to one embodiment detecting informal text content includes using metadata, which includes location and culture based information.

According to one embodiment the method may include detecting unidentified content other than misspelled content and/or the informal text content. The unidentified content can be inserted into an exception database.

According to other embodiments of the invention the method may include prioritizing the metadata to obtain prioritized content; and alerting the user to the existence of a message based on the prioritized content.

According to one embodiment the method may include scanning the metadata for pre-defined characteristics; assigning a score to the metadata based on the pre-defined characteristics; comparing the score assigned to the metadata to a pre-defined threshold and based on the comparison defining a priority of the metadata. Alerting the user to the existence of a message may be based on the priority of the metadata

The step of assigning a score to the tagged data based on the pre-defined characteristics may include assigning a weight to the score, the weight being dependent on a user identity, on a type of connected device employed by the user or on a combination thereof.

The pre-defined threshold may be dynamic and user specific and may include a statistical manipulation of the user's usage history. Alternatively, the pre-defined threshold may be static and unrelated to a specific user.

According to one embodiment that may include extracting visual content from available resources (such as public locations); and generating a visual presentation of the visual content. The visual presentation may include voice content, the origin of which is different than the origin of the visual content. The visual presentation may be a video.

According to other embodiment there is provided a method for processing and presenting content to a user. The method includes receiving input (e.g., voice input) from a web or connected device; creating a specific vocabulary based on pre-defined characteristics; processing the input based on at least one specific vocabulary and another vocabulary; and generating from the processed input a command or text.

The specific vocabulary may be a platform specific vocabulary, a location based specific vocabulary or a user specific vocabulary. Creating a specific vocabulary may be done off line or on the fly.

According to one embodiment a generic vocabulary may be processed together with a specific vocabulary.

The pre-defined characteristic may consists of: user personal information per the user account, such as age, gender, interest tags, hobbies, friends/contact list, groups, social activity history, Likes on specific content, check-in history, used vocabulary, user current physical geo-location, user's geo-location history, social network, or common public topics and'trends.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a system for processing and presenting content, according to one embodiment of the invention;

FIG. 2 schematically illustrates a method for processing and presenting non-voice content as speech, according to an embodiment of the invention;

FIG. 3 schematically illustrates a method for processing and presenting non-voice content as speech using platform specific information, according to an embodiment of the invention;

FIG. 4A schematically illustrates a method for processing and presenting non-voice content, according to another embodiment of the invention;

FIG. 4B schematically illustrates a method for processing and presenting a textual sentence, according to an embodiment of the invention.

FIG. 5 schematically illustrates a method for prioritizing content, according to an embodiment of the invention;

FIG. 6 schematically illustrates a method for presenting speech together with a visual presentation, according to an embodiment of the invention;

FIG. 7 schematically illustrates a method for processing and presenting voice/speech content as text, according to an embodiment of the invention; and

FIG. 8 schematically illustrates a method for processing and presenting voice/speech content as text using specific vocabularies, according to an embodiment of the invention.

### DETAILED DESCRIPTION OF THE INVENTION

Embodiments of the present invention provide a voice interactive platform which may be advantageously used in social networking such as provided by Facebook, Twitter etc. The platform may enable users with connected devices (such as feature/smart phones) to consume prioritized web based content and to generate personalized content.

According to one embodiment there is provided a system for processing and presenting web based and/or cellular network content and/or content from a connected device to a user. The system provides, according to some embodiments, a web server side solution which may interact with a user device or software having a web interface.

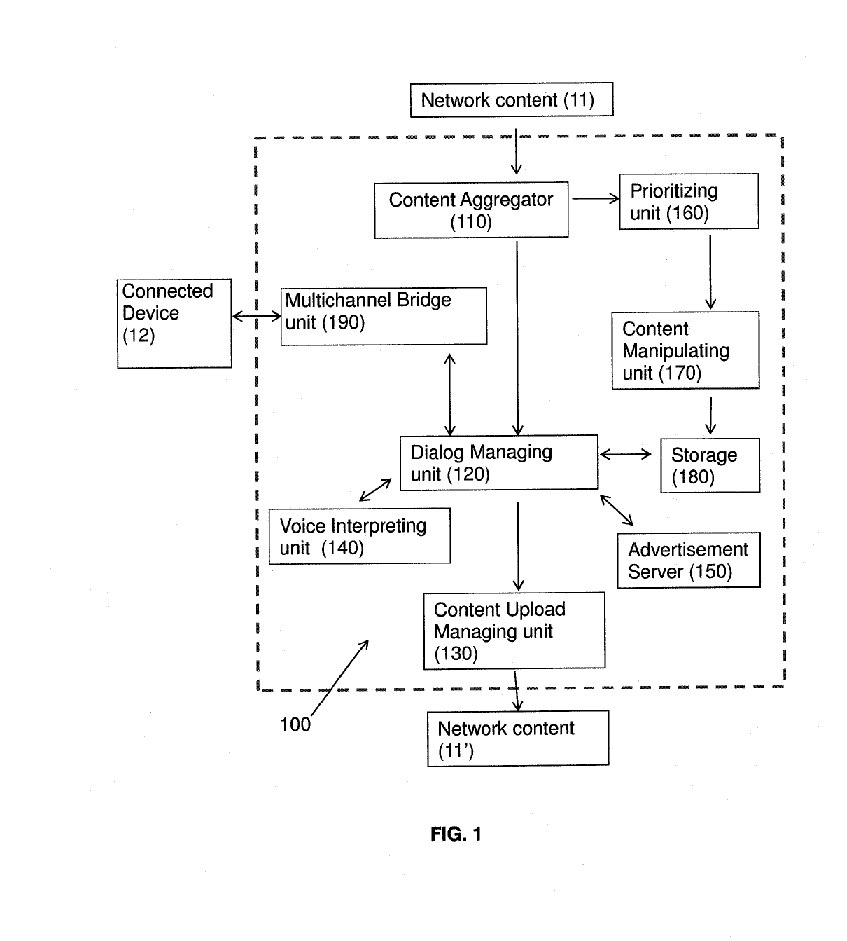

A system according to one embodiment is schematically illustrated in FIG. 1. The system 100, which is typically part of a remote server, includes a content aggregating unit 110 which is used to collect content 11 from a network. The content 11 is processed by a dialog managing unit 120 and is applied to a content upload managing unit 130 from which it is output as network content 11′.

Content received from or uploaded to a connected device 12 (such as a cellular/feature phone, smart phone or connected car phone) is directed via a multi-channel bridge unit 190 to or from the dialog managing unit 120.

According to some embodiments content processed by the dialog managing unit 120 may be applied to the multi-channel bridge unit 190 or transformed by a voice interpreter unit 140 prior to being applied to the content upload managing unit 130. Also, additional content, such as advertisements, may be inputted to the dialog managing unit 120, for example, by an advertisement server 150.

According to some embodiments content collected by the content aggregating unit 110 is prioritized by a prioritizing unit 160.

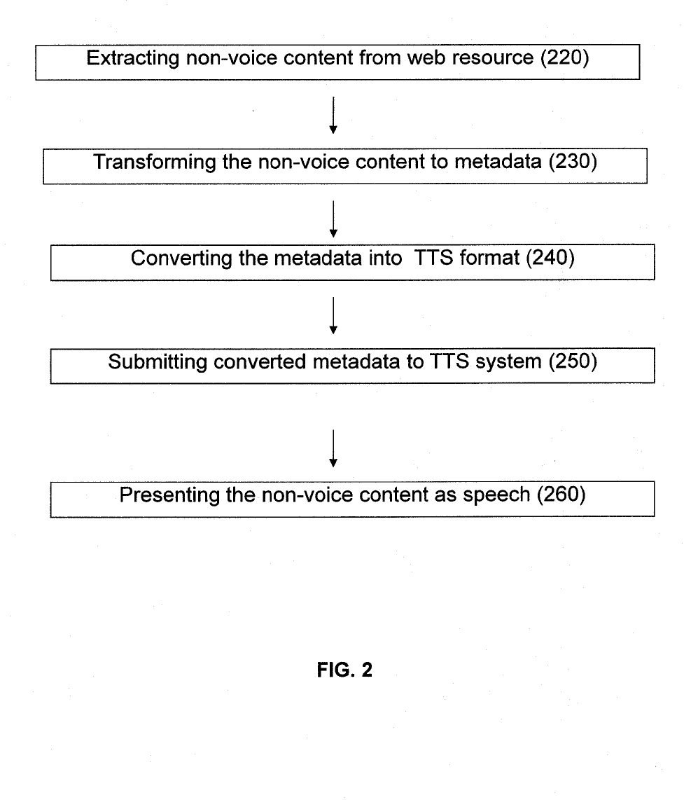

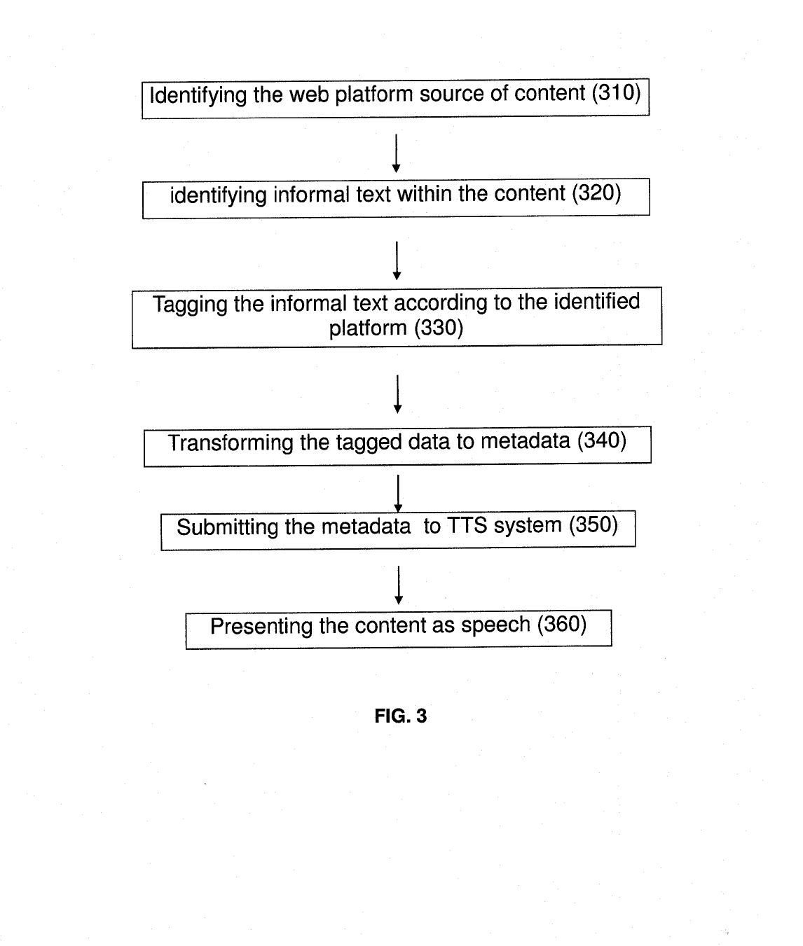

According to additional embodiments content (typically prioritized content) may be transformed to metadata by a content manipulating unit 170 (e.g., as described with reference to FIGS. 2 and 3) prior to being stored or applied to the dialog managing unit 120. Prioritized content and/or metadata may optionally be stored in storage 180 from which it can be retrieved by the dialog managing unit 120. According to some embodiments the dialog managing unit 120 may also store content in the storage 180.

According to one embodiment components of the system 100 are part of a remote operating system, such as a server. According to other embodiments some or all of the units of the system 100 may be device embedded. Thus, system 100 may be implemented on a cell phone, electronic notebooks/pads, PCs etc.

Content aggregating unit 110 typically collects content 11 from a network such as the web (e.g., using HTTP) or a cellular network. Content 11, which may be collected off line and/or in real-time, may include user content and/or public content from resources such as web pages, web links, photos (with or without tags), videos (with or without tags), user emails (e.g., Yahoo!, Googlemail etc.), user social networks (e.g., Facebook, Twitter, etc.) instant messaging services (e.g., Microsoft Messenger, ICQ, etc.), user VOIP services (e.g., Skype, JaJa, etc.) location based ads/content/applications/web sites (e.g. FourSquare). Cellular network content, which may be collected off line and/or in real-time, may include a device's cellular information such as CELLID, incoming SMS/MMS, etc.

In order to collect content 11 and share the content, the aggregating unit 110 may invoke a standard application programming interface (API) or other/additional web information techniques or formats such as RSS (really simple syndication), hypertext markup language JS (JavaScript), PHP (Hypertext Preprocessor) and more. For managing cellular network content the content aggregating unit 110 may enable services by accessing the mobile network.

The dialog managing unit 120 has the ability to connect to a connected device 12 while using the multi-channel bridge unit 190 that selects appropriate software or protocols for processing the content so that it is adequate for use by common interfaces, such as dial-in interactive voice response (IVR), smart phone (SP) applications, Data/IP/HTTP, Peer To Peer (P2P), voice over internet protocol (VOIP) phones/services, and public switched telephone network (PSTN). The multi-channel bridge unit 190 may deploy any software that will use it as a service (SaaS).

The collected content and other content inputted to the dialog managing unit 120 (such as advertisement content from the advertisement server 150) may be in different formats such as, non-voice (e.g., text and images), video, or audio. The content may be transformed from one format to another before it is output from the multi-channel bridge unit 190 to the connected device 12 and/or from the content upload managing unit 130 to the network as content 11′. For example, text content originating in the web may be transformed to voice and may then be outputted as voice to a connected device over VOIP. In another example, photos which originate in the web, may be attached to a voice message (which originates, for example, in the connected device/user) to create a video which will be posted to a web application, email, web page, etc. The dialog managing unit 120 may include an audio/video streaming source to enrich the content presented to the connected device.

The content upload managing unit 130 may be connected to different web and/or cellular services, such as Verizon Network, Facebook API, Google API, Microsoft/Bing API and so on. Content may be uploaded to users' accounts. The content upload managing unit 130 may use a user's preferences regarding output format and web services. For example, text/photos generated by the user and collected by the content aggregating unit 110, may be uploaded and transformed by the content upload managing unit 130 to text/file/font/format supported by the required web service. For example, photos in BMP format may be transformed to JPG if necessary. In another example a user's command may be fed to the content upload managing unit 130 such that it will invoke the appropriate web control while using, for example, API for platform specific controls and general common web surfing. For example, a “like” vocal input from a user may be translated to a Facebook “Like” action as if a button was pressed so that a story appears in the user's friends' News Feed with a link back to Liked content.

Content is typically processed by the dialog managing unit 120. The dialog managing unit 120 may operate methods and features per device or user application. According to some embodiments the system 100 may be used to convert user voice input to text or other non-voice presentation. A user may speak into a device, such as a microphone on a PC or a cell phone. The user's voice input will be typically processed by the voice interpreter unit 140 typically by running an engine to transform the vocal input into a command or text. The output text/command may then be fed to the dialog managing unit 120 for later processing.

The voice interpreter unit 140 may utilize a known Automatic Speech Recognition (ASR) engine to transform the user voice input to text or to a command. Other engines may be used, such as a Natural Language Processor (NLP). The voice interpreter unit 140 may run a unique process of using a combination of specific vocabularies in order to achieve accurate and quick transformation of the user's voice input to text or other output. The vocabularies may be created after processing user specific content from the content aggregating unit 110.

Alternatively, text content may be transformed to voice. An audio enhancement module may be used to reduce noise and enhance voice quality prior to adjusting the output format. All voice outputs may be uploaded as complete files or links to files that reside in a repository or may be played in real-time.

According to some embodiments advertisements may be presented to a user. The dialog managing unit 120 may present the advertisement server 150 with user specific characteristics (e.g., age, gender, topics of interest) and other information on the user (e.g., connected device capabilities and type; SP, IVR, geographic location which can be known from the user's GPS or from a cellular localizing system, such as a CELLID, for non GPS enabled user devices). Then, the dialog managing unit 120 may request the most relevant advertisement from a bank of ads and may present this ad via the multi-channel bridge unit 190 on a user's connected device 12. Ad format may be text, photos, video, or audio (voice).

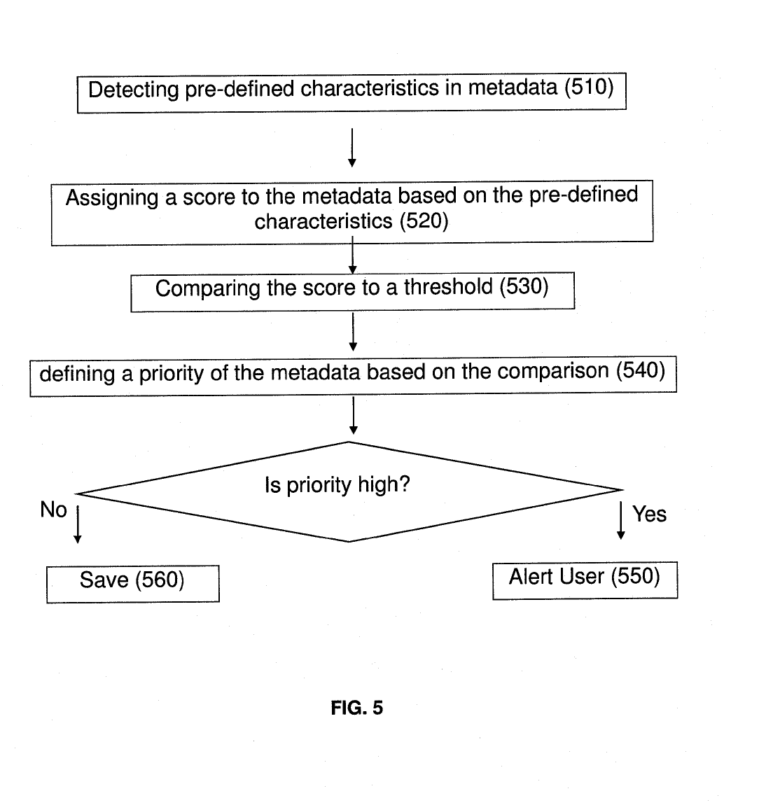

According to one embodiment a prioritizing algorithm may be applied on content collected by the content aggregating unit 110. The algorithm, typically applied by the prioritizing unit 160 is to identify high priority content (an example of such an algorithm is further described with reference to FIG. 5). A user may be alerted to high priority content incoming on his cellular or web network, e.g., by an SMS, MMS, push application alert, email, voicemail, buzzer, bell or other signal.

Some examples of algorithms and processes that may be employed by units of the system 100 are described below.

A method for processing and presenting non-voice content as speech, according to an embodiment of the invention is described with reference to FIG. 2. In a first step non-voice content is extracted from a network (e.g., web or cellular resource) (step 220). The web and cellular resources and techniques and formats for accessing these resources may be as described above. The non-voice content (typically text or other visual representation of data) is then transformed to metadata (step 230) and the metadata is then converted into a “text-to-speech” (TTS) engine input format (step 240). The metadata is then submitted to a TTS system (step 250) and the non-voice content may now be presented to a user as speech (step 260).

Transforming the non-voice content to metadata typically involves tagging the data according to specific features in a sequential, nested process. An algorithm scans the non-voice content according to sequential phases, each phase filtering the content and tagging the filtered content according to the features of that phase. An example of such a sequential process, according to one embodiment of the invention, is described in FIG. 3.

In one example, such as described in FIG. 3, a first filter is applied by identifying the platform of the web resource from which content was extracted (310). Some of the content includes known, formal text (such as words listed in a standard dictionary and forming grammatically correct sentences). The formal text may be submitted to a TTS system as known in the art. However, content from social networks or instant messaging platform resources typically includes informal text (also generally referred to as “slang”) such as intentionally misspelled words (e.g., “thx” instead of “thanks” or “whass up?” instead of “what's up?”) and/or platform specific text (e.g., “RT” stands for “ReTweet” in Twitter platform and “@johnsmith” may stand for “John Smith”). The algorithm may add flow wording (which would not be recognized as formal text) which suggests the origin of a message, the replier etc. Thus, the origin platform of the content has an impact on informal text and symbols in that content.

Once the platform source of content is identified informal text within the content may be identified (320) and the informal text is tagged according to the identified platform (330). The tagged data is then transformed to metadata (340).

Transforming tagged data to metadata, according to one embodiment, may be done by using hash tables. According to one embodiment a hash table is generated per platform. Phrases common to the platform are used as keys, each key being assigned a value that is a metadata textural representation or a reference to an audio file. For keys without values, values which are the most suitable information to represent that key, may be generated on the fly using information from the origin platform API, user history or other relevant sources.

The metadata, which is typically in a format suitable for submitting to a TTS system, is then submitted to a TTS system (350) and the content can then be presented to a user as speech (360) or saved as an audio file in a database (e.g., storage 180) for later use.

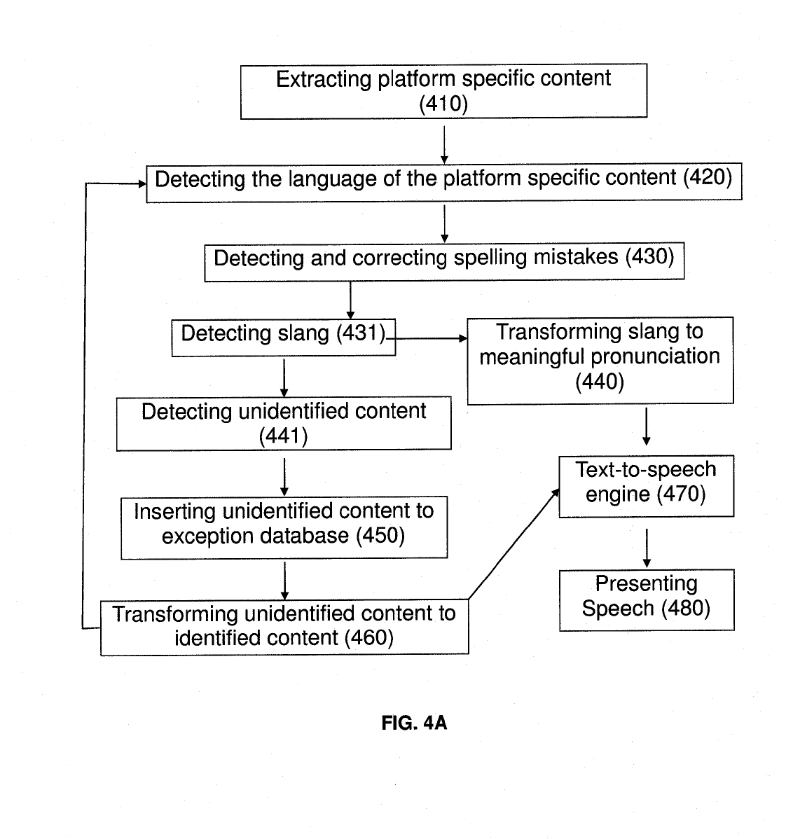

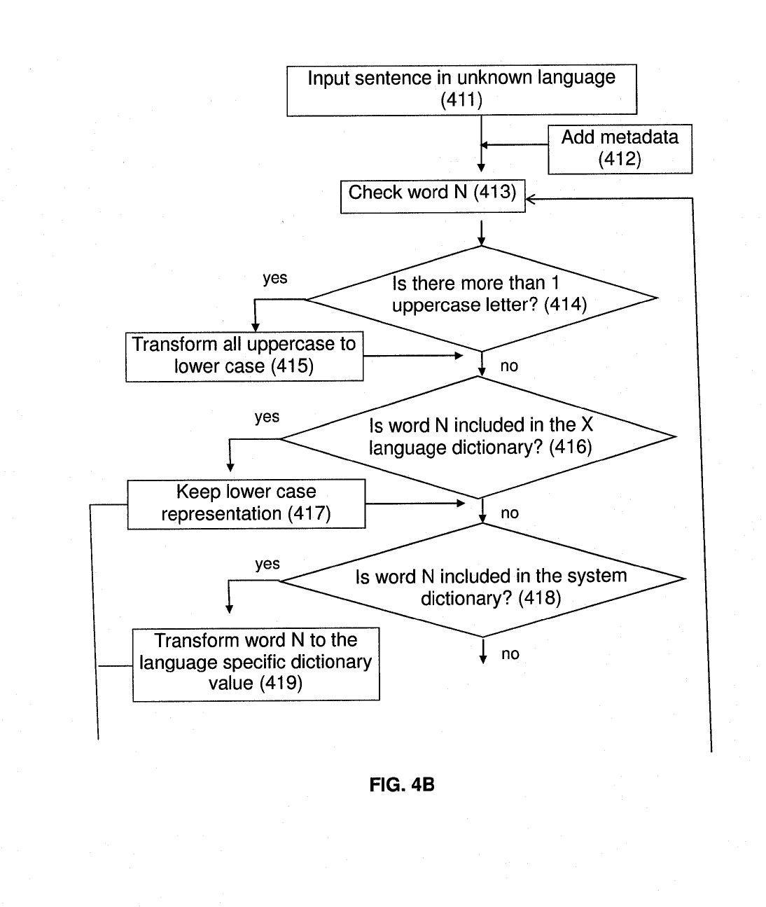

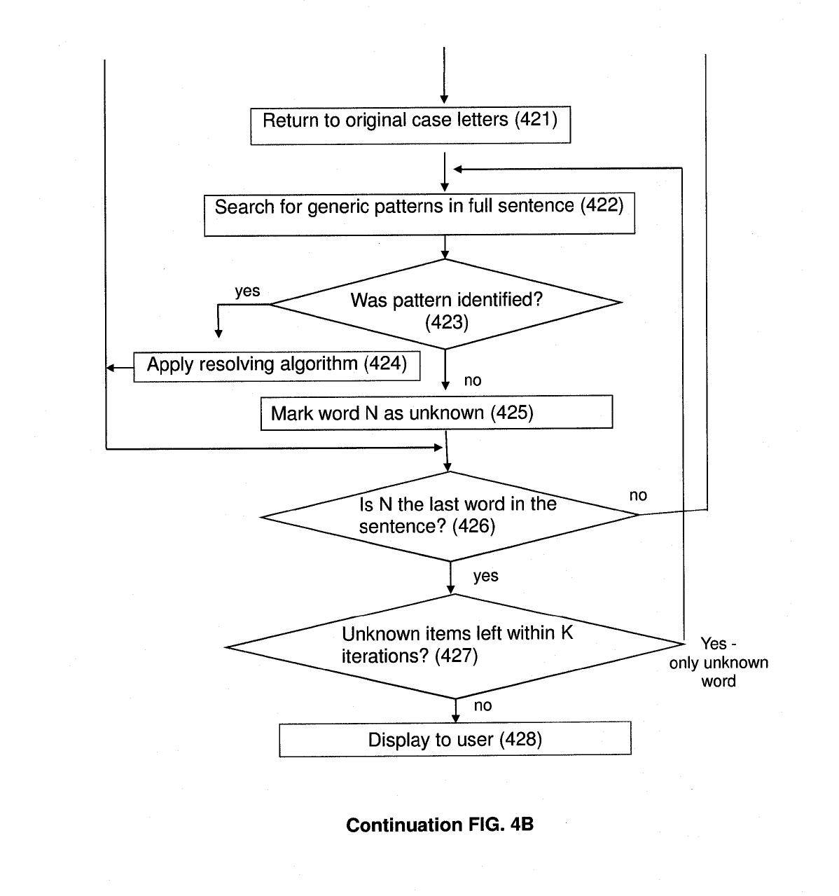

A method for processing and presenting non-voice content as speech, according to another embodiment of the invention, is described in FIG. 4A. According to one embodiment platform specific content is extracted (410) and as a first step the language of the content is detected (420). Content such as links may be removed and a web service may detect the language of the content.

In a second step spelling mistakes may be detected and corrected (430) in case of a high likelihood of guessing the correct word. Known word prediction methods may be applied.

In a next step slang words or phrases are detected (431). Common misspelled words (e.g., Whasss up?”), WWW/IM common shortcuts (e.g., LOL), symbols (e.g., smileys), language/textural errors (e.g., “hhhhh”) and other such informal text and symbols are examined per unique lingual database. According to one embodiment the lingual databases are available per geographic location, age, interests, and other characteristics of the user.

The detected informal text is transformed to a meaningful pronunciation (440). For example, “hhhhhhhh” will be transformed to a longer and more accentuated laughter sound than just “hhh”. Accentuated text, such as capital letters, may get a higher volume and urgent pronunciation. Typically the slang is transformed to sound effects that are supported by TTS engines. Additionally, proprietary audio files may be used.

In a next step content that has been through the detection steps above and is still unidentified (or identified as a mistake) (441), is inserted to an exception database (450) which may be examined, typically manually and off-line. After this examination unidentified content that has been transformed to identified content (460) may be run through the sequential process (e.g., starting at step 420) to be inputted to a TTS engine or may be directly inputted to the TTS engine (470) for being presented as speech (480).

According to one embodiment, a method for processing a textual sentence and transforming it to voice format (e.g., to a TTS engine compatible format) using multiple approaches is described with reference to FIG. 4B.

According to one embodiment, a language specific dictionary and a system dictionary per language are used to identify and transform instant message-like sentences into a clear textual representation that can processed well by a TTS engine.

According to one embodiment the system dictionary is built by the system to deal with informal language and contains location and culture based information such as phrases which are based on domain specific, culture dependent, location based common lingo, in addition to user's specific lingo, contact people, interests, previous correspondence, etc. The system dictionary may be generated in the server side, user side or a combination of them both using manual and automatic processes.

According to another embodiment textual pattern recognition methods may be used with reference to culture and domain characteristics in order to transform unstructured phrases into well structured text.

According to another embodiment of on-line web resources may be used to resolve unstructured text.

Additionally, according to another embodiment, a method of identifying words concatenation and splitting them to their original format includes a repetitive process of splitting successive letters into sub phrases and examining the different products until a clear identification is made.

In one embodiment, a sentence in an unknown (or yet unidentified) language is input into the system (411). Metadata is added (412). Metadata data can include information that relates to the context of the sentence, for example, domain (e.g., Facebook), geo-location, personal vocabulary, previously detected languages and more. The system then starts a process of language identification per word by checking word N within the sentence (413). If there is more than one uppercase letter in the word (414) then the word can be marked as “capital” (e.g., \Item=C_XXX, C illustrating “Capital”) and all upper case letters are transformed to lower case (415) (e.g., \Item=C_xxx). The system then checks if the word N is included in the X language (known language) dictionary (416). If the word N is found to be in a known language dictionary than the lower case representation is kept (417). If the word N is not found in any known language dictionary then the system checks if the word is found in the system dictionary (418) (which has been constructed by the system, for example, as described above). If the word N is found in the system dictionary then the word N is transformed to the dictionary value (419). If the word N is not found in the system dictionary after the above mentioned filters then the word is returned to its original case letters (421) and generic patterns are searched for in the full sentence (422). Generic patterns may include, for example, repetitive letters, symbols such as $ or @.

If a generic pattern was identified (423) a resolving algorithm is applied to the sentence (424) and the sentence can then be presented to the user (428). A resolving algorithm transforms the sentence to recognized terms (e.g., recognized by a TTS engine) that can then be presented (e.g., as voice) to the user. Examples of possible resolving algorithms include: transforming phrases per pattern (e.g., replacing $ with “s”), using on-line resources (e.g., @nickdonnelly gets stripped to first and last names using the domain specific API), exhaustively dividing and examining by splitting successive text per language characteristics and validating each product (e.g., “#wondervoice” is spliced to 1) #, 2) wonder and 3) voice). Other algorithms may be used. These algorithms may be performed at a remote server or on the user's device.

Generic patterns are examined for word N with reference to the previous and following words in the sentence.

If no generic pattern was identified (423) then the word N is marked as “unknown” (425) (e.g., \Item=UNKNOWN_XXX). Words marked as “unknown” may be further processed and once identified may be added to an exception database (e.g., 450).

The system then checks in N is the last word in the sentence (426). If it is determined that N is not the last word in the sentence then a subsequent word is processed as described above. If N is the last word in the sentence then the system checks if there are any unknown words left. This check is typically done only for a limited amount (K) of iterations. Typically, K equals the number of words in the sentence.

If there are unknown words left those unknown words are re-processed (e.g., from step 422) to try and resolve them. If there are no unknown words left then the sentence is displayed to a user (428).

According to some embodiments a user may be alerted to incoming content. According to some embodiments the content is prioritized and the user is alerted according to the priority assigned to the content.

FIG. 5 schematically illustrates a method for prioritizing content, according to an embodiment of the invention. Each incoming message or other content, which includes metadata, may be scanned for pre-defined, typically user specific, characteristics (510). Examples of pre-defined characteristics may include: user specific content attractions (e.g., restaurants, movies, etc.), user preferences per the user profile, physical geo-location, time related indications (e.g., today, yesterday, next week, etc.), social interaction history, most common public or user specific tags (e.g., Twitter/Flickr tags), latest news tags and more.

Each metadata is assigned a score (e.g., from 0-100) based on the characteristics (520). For example, each hit in the content may be counted and may be assigned a weight according to the specific characteristic. Thus, for example, when a user is using a car device, a higher weight may be assigned to location based characteristics than when the user is using a desktop device.

The overall content score may then be compared to a threshold (530) to define the priority of the content (540). The threshold may be a static, pre-defined threshold (such as a certain number of incoming messages) or a dynamic, user specific threshold (such as by using an average score per user). In a case of multiple sources of information (e.g., Facebook, Twitter and NY times RSS) a score may be added per source, for example, based on the user's usage history.

If the priority of a message or other incoming content is found to be “high” the user may be alerted (550) (for example, by buzzing, sending the user an SMS or email, push notification, signaling the connected device, etc.). Other, non “high” priority content may be saved (560) for later viewing by the user.

The process for determining priority of content may be run off line, on-line (on the fly) or partially on-line.

According to some embodiments a visual presentation may be displayed to the user, optionally together with presenting speech to the user. According to some embodiments the user may provide a visual presentation to other users, accompanied by his/her voice.

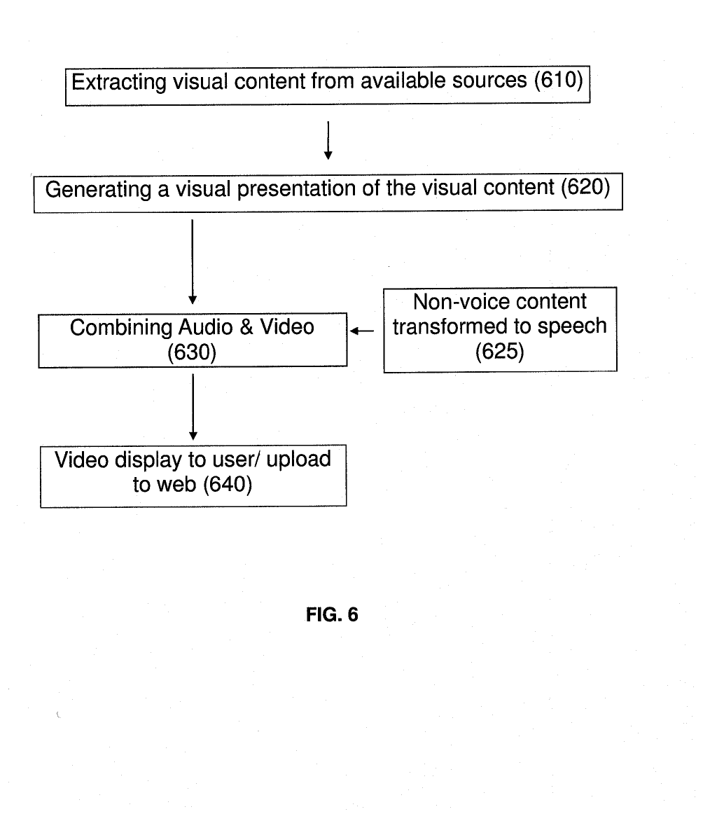

A method for presenting speech together with a visual presentation, according to an embodiment of the invention, is schematically illustrated in FIG. 6. Visual content may be extracted from available sources (610) and a visual presentation may be generated from the extracted visual content (620). Non voice content, if available, may be transformed to speech (625), for example, as described above and audio and video content are combined (630) to be displayed to a user (640). The visual content may be displayed to a user (e.g., as network content 11′ or via connected device 12) alone or together with voice content (as in step 630). The voice content may be a user's voice which is separate from the visual content or may be part of the visual representation (e.g., part of a video file).

Visual content may be extracted from sources such as: user info—public photos (e.g., in a facebook account), Google/Bing or other maps—geo-location visual, map/satellite view, street view etc., public domain location based info—weather, local attractions, local news etc.

The visual presentation, e.g., a video, may be generated based on templates or may be user selected or may randomly be selected by the system.

Templates may be composed of scenes and transitions, all selected from a bank/poll of available scenes/transitions. Each scene may be based on a static background image with an optional text overlay. Scenes may be described by XML or other descriptive text file formats (e.g., SCXML).

Thus, provided by embodiments of the present invention is an application which enables a user to provide information (e.g., status update) by a visual presentation (e.g., video) accompanied by the user's own voice.

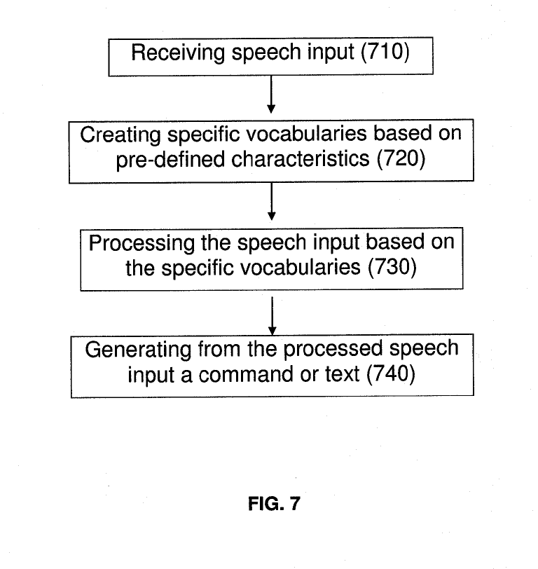

A method according to embodiments of the invention enables user voice input to be transformed to text. FIG. 7 schematically illustrates a method for processing and presenting voice/speech content as text, according to an embodiment of the invention.

According to an embodiment of the invention voice input is processed by using multiple vocabularies. According to one embodiment the method includes receiving speech input (710) and creating specific vocabularies based on pre-defined characteristics (720). The specific vocabularies are used to process the speech input (730) to output a text or command (740). Vocal inputs may be processed, e.g., by the vocal interpreter unit 140, using known engines such as ASR and NLP.

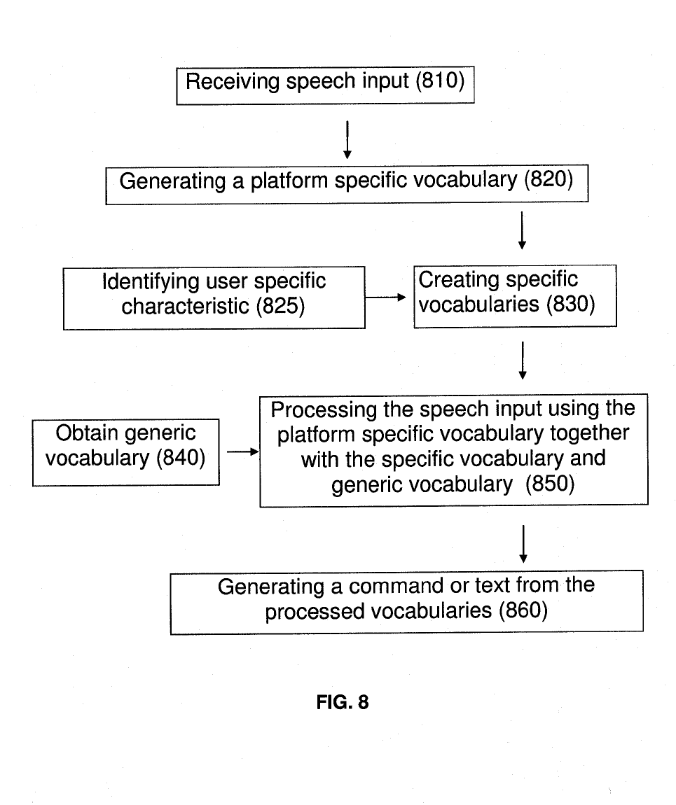

A method for processing and presenting voice/speech content as text using specific vocabularies, according to an embodiment of the invention, is described with reference to FIG. 8.

According to one embodiment, voice input is received (810). In one step the platform being used by the user is identified and a platform specific vocabulary is generated (820). The platform specific vocabulary may include specific terms (e.g., in facebook—“like”, “check-in”, “poke” and in Twitter—“re-tweet”, etc.). A user specific vocabulary is then created (830). The user specific vocabulary may be generated by identifying user specific characteristics (825) and using these characteristics to create the user specific vocabulary. User specific characteristics may include user specific content and tags, user current physical geo-location, user's geo-location history, social network, or common public topics and trends. One example of user specific characteristics includes user personal/friends info per the user account; age, gender, interest tags, groups, photos, hobbies, contact list, likes on specific content, check-in history, used vocabulary etc. Another example of user specific characteristics includes user geo-location info per ,a detected location; the physical location can be used with complementary web services to extract nearby venues, places and so on, which are included in the specific vocabularies.

According to one embodiment a generic vocabulary is also used. A generic vocabulary is obtained (840) (may be created ad hoc or an already existing generic vocabulary may be used) and the voice input is processed using a platform specific vocabulary (optionally together with another specific vocabulary) and the generic vocabulary (850). Output of the process generates text, or a command (860).

Vocabularies may be created off-line or on the fly. For example, a platform specific vocabulary may typically be created off-line (although it can be created on the fly as well).

The use of multiple vocabularies (rather than a single vocabulary), some specific per case, maximizes voice transcript detection success.

Although the above examples relate to transforming voice input to non-voice, the use of a plurality of vocabularies according to embodiments of the invention, may be applied to other input formats (such as text, photos, etc.).

The system and method according to embodiments of the invention yield a high transformation success rate and also enable faster search times, thereby providing a new, user friendly application for facilitated user interaction with content.

1. A method for processing content, carried out using an electronic processor the method comprising
transforming non-voice content to metadata;
mapping the non voice content to the metadata;
transmitting the metadata to a connected device said connected device is configured to determine a single metadata object to use as input to a text-to-speech system;
converting the metadata to a format suitable for submitting to the text-to-speech system;
submitting the converted metadata to the text-to-speech system; and
presenting the non-voice content as speech.

2. The method according to claim 1 comprising extracting the non-voice content from a network.

3. (canceled)

4. The method according to claim 2 wherein the network comprises a social network, an instant messaging textual representation service or a combination thereof.

5. The method according to claim 1 wherein the non-voice content comprises informal text.

6. The method according to claim 5 comprising
extracting non-voice content from a web resource;
identifying informal text within the non-voice content; and
transforming the identified informal text to metadata prior to converting the metadata into a format suitable for submitting to a text-to-speech system.

7. The method according to claim 6 wherein transforming the identified informal text to metadata comprises
tagging the informal text in a platform specific manner to obtain tagged data; and
transforming the tagged data to metadata.

8. The method according to claim 7 further comprising
detecting the language of the tagged data;
detecting misspelled content;
correcting spelling mistakes in the misspelled content;
detecting informal text content; and
transforming the informal text content to a format suitable for submitting to a text-to-speech system.

9. The method according to claim 8 comprising detecting misspelled content by using a dictionary of the detected language, wherein misspelled content is case insensitive.

10. The method according to claim 8 wherein detecting misspelled content comprises using metadata, the metadata comprising web related content and wherein the misspelled content is transformed to a format usable by a text-to-speech system.

11. The method according to claim 8 wherein the misspelled content comprises successive words with no blank spaces in between the words with or without special characters in between the words.

12. The method according to claim 8 wherein detecting informal text content comprises using metadata, the metadata comprising location and culture based information.

13. The method according to claim 8 comprising
detecting unidentified content other than the misspelled content and/or the informal text content; and
inserting the unidentified content into an exception database.

14-19. (canceled)

20. The method according to claim 1 further comprising
extracting visual content from available resources; and
generating a visual presentation of the visual content.

21. The method according to claim 20 wherein the visual presentation comprises voice content the origin of which is different than the origin of the visual content.

22. The method according to claim 20 wherein the available resources comprise public locations.

23. The method according to claim 20 wherein the visual presentation comprises a video.

24. A method for processing and presenting content to a user, the method being carried out on an electronic processor, the method comprising
receiving voice input from a web or connected device;
transforming pre-defined characteristics to metadata said metadata is configured to be used as input for a text-to-speech engine;
creating a specific vocabulary based on the metadata;
processing the voice input using a voice-to-text engine with at least one specific vocabulary and another vocabulary; and
generating from the processed voice input a command or text.

25. The method according to claim 24 wherein the at least one specific vocabulary is a platform specific vocabulary, a location based specific vocabulary or a user specific vocabulary.

26. The method according to claim 24 wherein creating a specific vocabulary is off line or on the fly.

27. The method according to claim 24 comprising processing a generic vocabulary together with a specific vocabulary.

28. The method according to claim 24 wherein the pre-defined characteristic consists of: user personal information per the user account, such as age, gender, interest tags, hobbies, friends/contact list, groups, social activity history, Likes on specific content, check-in history, used vocabulary, user current physical geo-location, user's geo-location history, social network, or common public topics and trends.

29. The method according to claim 1 comprising:
choosing the metadata objects based on the connected device metadata, wherein
the choosing is preformed with reference to specific characteristics.

30. The method according to claim 24 wherein the at least one specific vocabulary is a platform specific vocabulary, or a location based specific vocabulary or a user specific vocabulary or a combination thereof.

31. The method according to claim 24, comprising creating the specific vocabulary from a group consisting of:
previous correspondence, and/or lists, and/or groups, and/or interests, and/or user current physical geo-location, and/or nearby venues, and/or music history, and/or check-in history, and/or friends names, and/or friends content.

32. The method according to claim 24, wherein the specific vocabulary comprises a specific vocabulary entry, said specific vocabulary entry is created
from a textual phrase that is transformed into metadata and wherein said metadata is configured to be inputted to text-to-speech engine.

33. The method according to claim 24, comprising:
including the metadata as part of the specific vocabulary, said specific vocabulary is configured to be inputted to voice-to-text engine.

34. The method according to claim 24, wherein the text is processed by invert transformation from said metadata to a textual phrase.
